(19) United States
(12) Patent Application Publication
(10) Pub. No.: US 2017/0034055 A1
(43) Pub. Date: Feb. 2, 2017

(54) Handling Consumer Mobility in Information-Centric Networks

(71) Applicant: Futurewei Technologies, Inc., Plano, TX (US)

(72) Inventors: Ravishankar Ravindran, San Ramon, CA (US); Guoqiang Wang, Santa Clara, CA (US); Asit Chakraborti, Pleasanton, CA (US)

(21) Appl. No.: 14/811,161

(22) Filed: Jul. 28, 2015

(51) Int. Cl. H04L 12/741; H04W 40/24

(52) U.S. Cl. CPC H04L 45/745; H04W 40/246

(57) ABSTRACT

Computer-implemented methods, computer software, and computer systems for handling consumer mobility in an information-centric networks (ICN). A pending interest table (PIT) including one or more PIT entries is maintained by an attachment point (AP) of a user equipment (UE) in the ICN. Each PIT entry identifies unsatisfied data requested by the UE. The data requested by the UE are specified in one or more interest packets that were previously received by the AP. An interest packet is received at the AP. The interest packet includes an identifier (ID) of a UE and a name of data that the UE requests. A PIT entry is identified by the AP. The PIT entry includes the name of the data requested by the UE in the interest packet. An index mapping the UE to the PIT entry is generated by the AP based on the ID of the UE.

### BACKGROUND

Information-centric network (ICN) is a network that allows applications to bind to application-centric identifiers (IDs) exposed to the network layer entity (ID can represent content, device, service, etc.), rather than to bind with one specific form of naming like an IP address that represents physical location where that data is to be retrieved from, named hosts.

In a regular host-centric network (for example, an Internet protocol (IP) network), data is exchanged based on one or more host addresses (for example, IP addresses). Packets are delivered based on an end-to-end principle from a source address to a destination address.

In an ICN, on the other hand, packets are exchanged based on the name of the content or data. A content-centric network (CCN) or named data network (NDN) is an example implementation of the ICN that permits fetching data identified by a given name. The potential benefits of ICN include content caching to reduce congestion and improve delivery speed, simpler configuration of network devices, and improved mobility support.

### SUMMARY

The present disclosure involves systems, software, and computer-implemented methods for handling consumer mobility in information-centric networks (ICNs).

In general, one aspect of the subject matter described here can be implemented as a method performed by an attachment point of a user equipment (UE) in an information-centric network (ICN) that includes a number of network nodes. The method includes maintaining, by the attachment point and in a computer-readable storage device, a pending interest table (PIT) that includes one or more PIT entries, each of the one or more PIT entries identifying unsatisfied data requested by the UE, wherein the data requested by the UE are specified in one or more interest packets that were previously received by the attachment point; receiving, at the attachment point, an interest packet including an identifier (ID) of a UE and a name of data that the UE requests to receive from one of the number of network nodes through the ICN; identifying, by the attachment point, a PIT entry of the PIT, the PIT entry including the name of the data requested by the UE in the interest packet; and generating, by the attachment point, an index mapping the UE to the PIT entry based on the ID of the UE.

In some instances, one aspect of the subject matter described here can be implemented as a network node. The network node includes a computer-readable storage device, and at least one hardware processor interoperably coupled with the computer-readable storage device and configured to operate as an attachment point of a user equipment (UE) in an information-centric network (ICN) that includes a number of network nodes. The at least one hardware processor configured to perform operations including maintaining, by the attachment point and in the computer-readable storage device, a pending interest table (PIT) that includes one or more PIT entries, each of the one or more PIT entries identifying unsatisfied data requested by the UE, wherein the data requested by the UE are specified in one or more interest packets that were previously received by the attachment point; receiving, at the attachment point, an interest packet including an identifier (ID) of a UE and a name of data that the UE requests to receive from one of the number of network nodes through the ICN; identifying, by the attachment point, a PIT entry of the PIT, the PIT entry including the name of the data requested by the UE in the interest packet; and generating, by the attachment point, an index mapping the UE to the PIT entry based on the ID of the UE.

In some instances, one aspect of the subject matter described here can be implemented as a non-transitory computer-readable medium storing instructions executable by an attachment point of a user equipment (UE) in an information-centric network (ICN) to perform operations. The operations include maintaining, by the attachment point and in the computer-readable storage medium, a pending interest table (PIT) that includes one or more PIT entries, each of the one or more PIT entries identifying unsatisfied data requested by the UE, wherein the data requested by the UE are specified in one or more interest packets that were previously received by the attachment point; receiving, at the attachment point, an interest packet including an identifier (ID) of a UE and a name of data that the UE requests to receive from one of the number of network nodes through the ICN; identifying, by the attachment point, a PIT entry of the PIT, the PIT entry including the name of the data requested by the UE in the interest packet; and generating, by the attachment point, an index mapping the UE to the PIT entry based on the ID of the UE.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features and advantages of the disclosure will be apparent from the description and drawings, and from the claims.

### BRIEF DESCRIPTION OF THE DRAWINGS

FIG. 1 is a block diagram showing an example network architecture of an information-centric network (ICN).

FIG. 2 is a block diagram showing another example network architecture of an ICN with an example configuration of an ICN attachment point (AP) or forwarder.

FIG. 3 is a block diagram showing an example ICN that is configured to handle consumer mobility.

FIG. 4 is a flow chart of an example process for handling consumer mobility in an ICN.

### DETAILED DESCRIPTION

In some instances, example techniques for handling consumer mobility in information-centric networks (ICN) are disclosed. An ICN can include multiple network nodes (also referred to as ICN nodes, routers, or forwarders) and can serve multiple data consumers (also referred to as clients, user equipment (UE), mobile nodes, or mobile devices in some instances). The communication between the network nodes and the UE can be based on the name of the data (or content, content object). For example, the name can be self-certified ID, a human-readable name, a series of name prefixes, or other identifier of the data. Example data names can include “figure.jpeg,” “abcd.com/xyz-video,” etc. The names can be location-independent and can be much more flexible than Internet protocol (IP) addresses.

Communication in ICN includes the exchange of two types of packets: interest packet and data packet. A data consumer can specify the name of a desired piece of data in an interest packet and send the interest packet to the network. Routers use this name to forward the interest packet toward one or more data providers or producers. Once the interest packet reaches a node that has the requested data, the node will return a data packet that contains both the name and the content. The data packet can follow, in reverse, the path taken by the interest packet to get back to the requesting consumer. Unlike in IP's end-to-end packet delivery model, the interest and data packets carry names of the data but not any host or interface addresses, thus avoiding the need of specifying source or destination nodes in data delivery.

In some instances, the data consumer or the data provider can change its location in the network. It is desirable for the ICN to provide continuous connections in the event of network configuration such as consumer mobility (for example, when the data consumer moves) and provider mobility (for example, when the data producer moves). As an example of consumer mobility, the data consumer can be registered with a first AP and later moves to a location served by a second AP. Without support for the consumer mobility, the data consumer may not be able to get the requested data because the ICN does not know where the data consumer has moved and may still send the responded data packets to the previous from which he/she sent the interest packet.

A current solution to consumer mobility is to allow consumer application or the content-centric network (CCN) layer to retransmit the interest packets when the consumer moves. This approach leads to best effort mobility support because, in the worst case scenario, the interest packets may not repeat the previous path and go all the way to the data producer.

The example techniques disclosed herein can provide a guaranteed seamless mobility for the consumer through a control plane that ensures the pending interest responses from the consumer are re-directed to the its new location. The example techniques introduce a data structure that is unique for each consumer that indexes into the pending interest table (PIT) data structure pointing to the outstanding interests from the consumer in the PIT. The example techniques allows a unique identifier of the data consumer to be included in interest packets. The identifier of the data consumer remains the same even if the location of the data consumer changes. When the attachment point (AP, for example, an ICN router) of the data consumer receives the interest packets, the data structure indexes the pending interest of the data consumer based on the identifier of the data consumer. When the ICN router learns about the mobility of the data consumer, the ICN router can locate and keep track of the pending interest associated with the data consumer by referring to the data structure based on the identifier of the data consumer. In addition, the example techniques provide signaling (for example, explicit signaling) between the data consumer and its attachment point (also referred to as the point of attachment (PoA)) and signaling between APs to notify the mobility of the consumer. As such, the example techniques can handle consumer mobility in a seamless manner and allow data consumers to re-configure their network locations without disrupting connectivity.

The example techniques can achieve more guaranteed performance towards consumer mobility and more efficient and effective use of the network resources. In some implementations, the example techniques can be application agnostic such that data consumers and producers can be unaffected (for example, in terms of communications and networking performances) due to mobility. The example techniques allow consumer mobility to be handled in a seamless manner that minimizes or otherwise reduces the loss of interest packets or data packet in the network and thus alleviate or avoid the reliance on best-effort re-transmission for recovery. In some implementations, the example techniques allow some network functions along with re-transmission for faster recovery of pending interest packet. The example techniques can reduce or avoid consuming or occupying the network resources to repeat the interest packet path all the way to the data producer. In some implementations, the example techniques enable mobility to be handled locally and not cause global update such as routing updates, and thus minimize or otherwise reduce the impact to other components of the network.

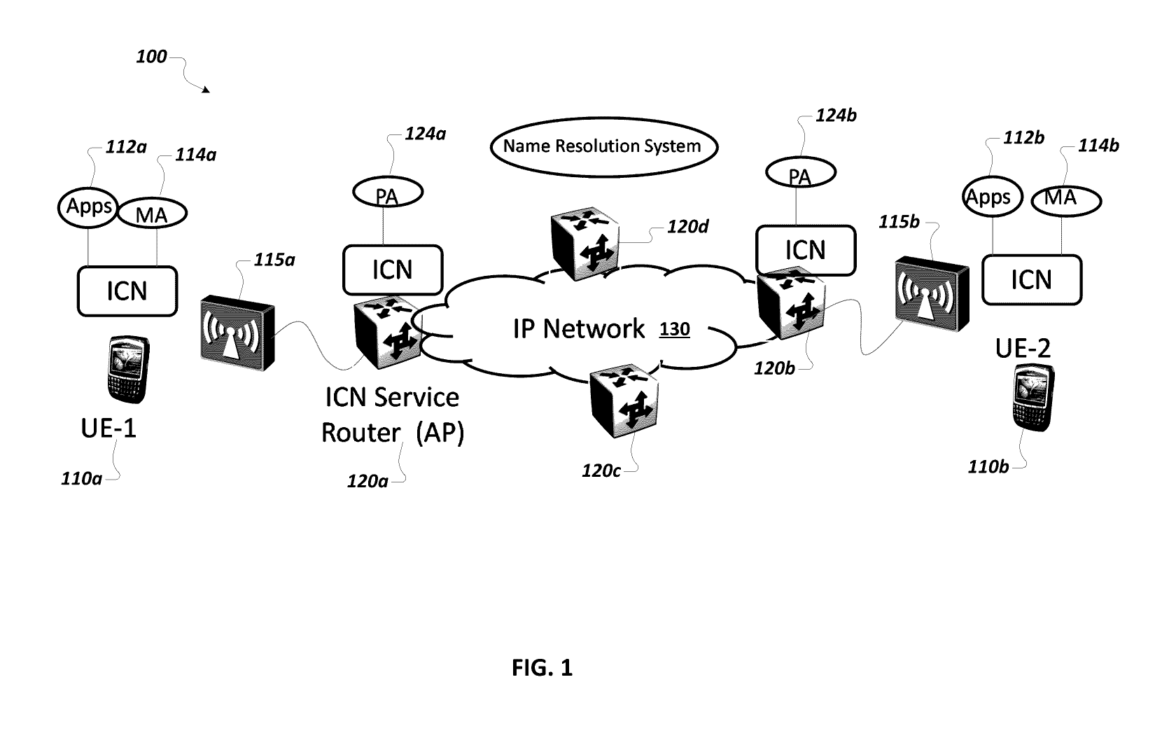

FIG. 1 is a block diagram showing aspects of an example architecture of an information centric network (ICN) 100. The example ICN 100 includes multiple data consumers, for example, a first user equipment (UE-1) 110a and a second UE-2 110b, and multiple ICN service routers 120a, 120b, 120c, and 120d. In implementations where ICN is deployed as an IP overlay, the ICN service routers 120a-d are overlaid over an IP network 130 with a single-hop ICN level logical reachability between them. The UE-1 110a and UE-2 110b are attached to or otherwise establish communication with the ICN service routers 120a and 120b through one or more access points, for example, a first access point 115a and a second access point 115b (for example, access points of a WiFi network, base stations of a cellular network, access gateways, or other access points), respectively. As such, the ICN service routers 120a and 120b can be referred to as attachment points (APs) or points of attachment (PoAs) for the UEs 110a and 110b. The UEs 110a and 110b can support multiple applications 112a and 112b and request and process data for the multiple applications 112a and 112b

In some implementations, the data consumers and the ICN service routers can include a control plane and a forwarding plane. The forwarding plane can be configured to execute network layer logic, for example, to encapsulate, extract, encode/decode, transmit/receive, or otherwise process data between two or more network nodes (e.g., the UEs and the ICN routers) of the ICN 100.

The control plane can be configured to control the connectivity properties and manage the mobility of the network components. For example, each of the UEs 110a and 110b can have a respective mobile agent (MA) 114a or 114b; while the ICN service router 120a or 120b can enable a respective proxy agent (PA) 124a or 124b. The MA and PA may be implemented as software module, hardware components, or a combination thereof to support seamless mobility. The functions of the MA and PA can include, for example, forwarding and control functions.

For example, at the UEs 110a and 110b, the MA 114a and 114b can implement a protocol or logic to execute control functions, such as UE registration/de-registration, sending notification messages during mobility, handoff operations, and other control functions. The MA 114a or 114b can be configured to transmit interest packets to request data for applications 112a and 112b from data producers (not shown) in the ICN 100 through the ICN service routers 120a-d.

At the ICN service routers 120a-d, the PA 124a or 124b may be configured to manage one or more UEs that are attached to the ICN service routers 120a-d, keep track of associated states in terms of mobility properties, and execute processing of interests and data responses to achieve seamless mobility. For example, the PA 124a or 124b can be configured to perform forwarding and control functions. For example, upon receipt of the interest packets from the UEs 110a and 110b, the PA 124a or 124b can execute logic to forward the interest packets to other ICN service routers or the data producers based on the names carried in the interest packets. On the other hand, the ICN service routers 120a-d can receive data packets responded from the data producers or other ICN service routers, and forward the data packets to corresponding UEs that requested the data. In some implementations, the ICN service routers 120a-d can include MAs (not shown) that are configured to handle some operations of the PAs 124a and 124b to support seamless mobility.

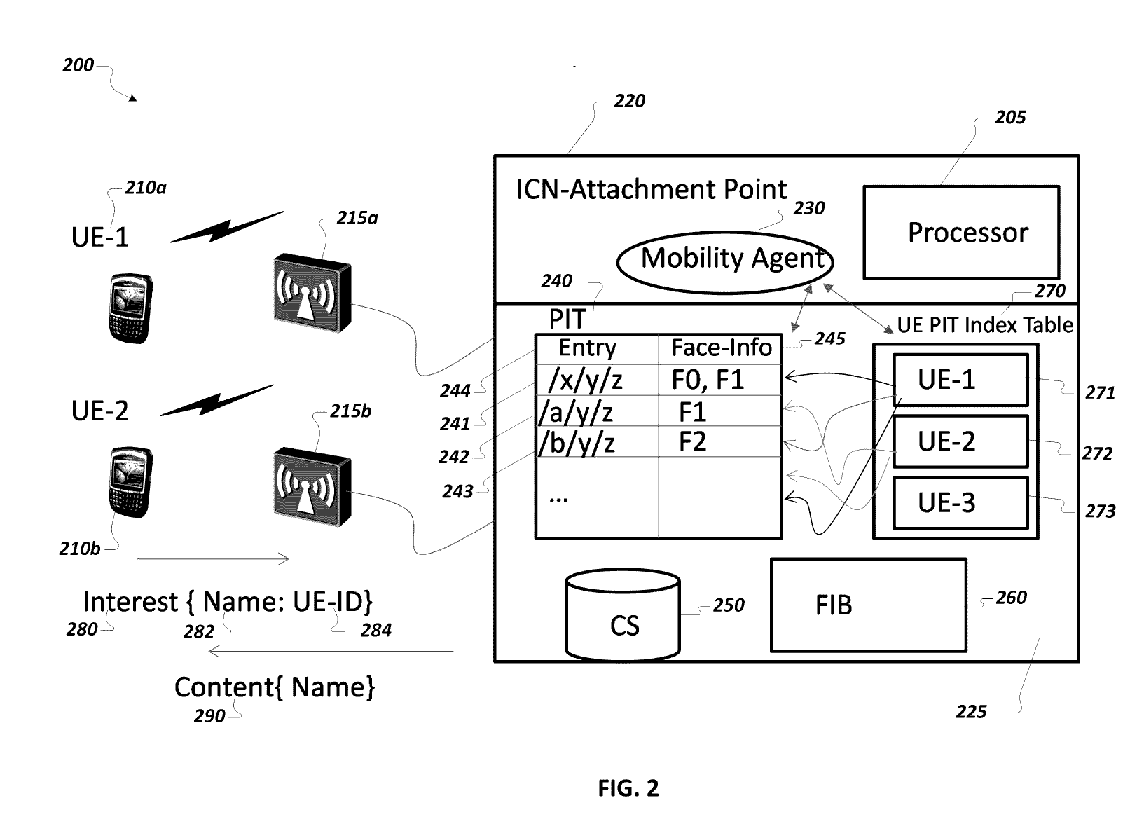

FIG. 2 is a block diagram showing another example network architecture of an ICN 200 configured to handle consumer mobility. The ICN 200 include UEs 210a and 210b and an ICN forwarder 220. As described below, the UEs 210a and 210b in the ICN 200 include their identifiers in the interest packets and the ICN forwarder 220 includes UE-specific data structures to facilitate tracking the UE as it changes its location within the ICN 200.

The ICN forwarder 220 can be implemented by an ICN service router, for example, one of the ICN service routers 120a-d in the example ICN 100 in FIG. 1 or another network element of an ICN. As shown in FIG. 2, the UEs 210a and 210b are attached to the ICN forwarder 220 through respective access points 215a and 215b. The ICN forwarder 220 serves as the ICN attachment point (AP) for the UEs 210a and 210b and is configured to perform interest and data packets forwarding functions and support seamless consumer mobility.

The ICN forwarder 220 includes a computer-readable storage device 225 and at least one hardware processor 205 inter-operably coupled with the computer-readable storage device 225. In some implementations, the ICN forwarder 220 includes a mobility agent (MA) 230 that is configured to provide network mobility service and execute functions such as forwarding and controlling interest and data packets.

The ICN forwarder 220 maintains a pending interest table (PIT) 240, content store (CS) 250, and forwarding information base (FIB) in the computer-readable storage device 225. The PIT 240 can store all the interest packets that the ICN forwarder 220 has forwarded but not satisfied yet. The PIT 240 can include multiple PIT entries 241, 242, 243, etc. Each PIT entry can include the data name 244 (for example, corresponding to the data name carried in the interest packet) and locator information 245 that records the incoming and/or outgoing interface(s) which the interest packet came from or is to be forwarded to. For example, as shown in FIG. 2, the entry 241 corresponds to the data name “/x/y/z” with an incoming face F0 and F1. The CS 250 can be a temporary cache of data packets that the ICN forwarder 220 has received. The ICN forwarder 220 can cache or otherwise store data packets to satisfy future interest packets, for example, from another consumer or for the purpose of multicast. The FIB 260 can include a routing table which maps name components to interfaces. For example, the FIB 260 itself can be populated by a name-prefix based routing protocol and can have multiple output interfaces for each prefix. In some implementations, the ICN forwarder 220 can maintain a forwarding strategy module (not shown) that includes a series of policies and rules about forwarding packets. The ICN forwarder 220 can forward interest and data packets according to certain forwarding strategies, for example, based on the information included in the interface 245 of the PIT entries and the FIB 260.

In addition to the PIT 240, CS 250, and FIB 260, the ICN forwarder 220 can further maintain an additional data structure, a UE PIT index table 270, created for handling consumer mobility to keep track of the pending interest packets from a UE. The UE PIT index table 270 can include multiple entries 271, 272, 273, etc. Each entry corresponds to a respective UE and can be identified by the UE ID. Each entry can be an index that maps the UE to the corresponding PIT entries in the PIT 240 that are associated with the UE. Example techniques for creating or otherwise maintaining the UE PIT index table 270 and its entries are described in greater detail below.

In some aspects of operations, when a UE (for example, UE-1 210a or UE-2 210b) registers or otherwise connects to an attachment point (AP), for example, the ICN forwarder 220, the attachment point can create a state for UE at the PA. The state can include both control and forwarding plane states. The state in the forwarder would allow the interest packets to be identified as those belonging to the UE ID.

Once the UE is connected, the AP can provide consumer mobility to the UE, for example, by operations of the MA 230. For instance, each UE can have a UE ID that uniquely identifies the UE regardless of the US's location. For example, the UE ID can be a network assigned ID that remains the same across difference subnets of the ICN 100. Examples of the UE ID can include a secure ID (for example, a hash of a public key), human-readable name of the UE, or any other identifiers.

In some implementations, in addition to the metadata that an interest packet includes for transmission over an ICN, the interest packet (for example, the interest packet 280) specifically includes the UE ID that uniquely identifies the UE, as opposed to identifying the UE's association with any particular network or subnet. The UE ID can be included in the interest packet transmitted by the UE or forwarded by the ICN service routers. For example, as shown in FIG. 2, the interest packet 280 can include the name 282 of the requested data (or content) and the UE ID 284 of the UE. The UE ID 284 can be implemented as a prefix, suffix, or otherwise included in the interest packet 280.

When receiving the interest packet 280, the ICN forwarder 220 can identify the UE ID 284. In some implementations, for the ICN forwarder 220 to identify the UE ID, signaling between the control planes may be required to monitor mobile flows with the set of UE IDs being served by the ICN forwarder 220.

Based on the UE ID 284, the ICN forwarder 220 can create a UE PIT index that indexes into the PIT entries corresponding to the UE. In some implementations, the UE PIT index can be stored individually, or the UE PIT index can be stored as an entry of the UE PIT index table 270 in the computer-readable storage device 225. For instance, the UE PIT index can be implemented by a pointer, a reference, or another data structure. The UE PIT index can include more than one PIT entry that is associated with the UE. For example, as shown in FIG. 2, the entry with UE ID, UE-1, indexes to the PIT entries 241, 242, and 243 in the PIT 240, indicating that the UE-1 has requested and is waiting for data named in the corresponding PIT entries 241, 242, and 243.

In some implementations, when the ICN router 220 receives an interest packet including the UE ID (for example, the interest request 280 including the UE ID 284), the ICN router 220 can first check the content store 250 for data that matches the data name 282 in the interest request 280. If matching data exists, the ICN router 220 can return the matching data in a data packet via the interface from which the interest came.

When a data packet 290 flows back, the ICN forwarder 220 finds the matching PIT entry in the PIT 240 and forwards the data 290 to all down-stream interfaces listed in that PIT entry (for example, listed in the location or face information 245). The ICN forwarder 220 then removes that PIT entry, and the entries in the PIT consequently represent unsatisfied interests. The ICN forwarder 220 can cache the data 290 in the content store 250. Data packet packets always take the reverse path of corresponding interest packets. In addition, the UE PIT index table 270 is also updated based on the latest set of PIT interest packets outstanding from the UE. For example, if a PIT entry associated with a UE is removed, the mapping from the UE to the removed PIT entry is also removed from the UE PIT index with the UE ID.

In some implementations, the UE PIT index table 270 is only used when a UE moves. When the UE moves, the UE can signal the AP about its mobility. The AP can update the locator information of the PIT entries based on the mobility information received from the UE. In some instances, the AP can notify another AP about the mobility of the UE. The UE can move between subnets but within the same AP, where only the locator (for example, incoming and/or outgoing interface(s)) associated with the UE changes. Alternatively, the UE can move between two different APs, where both the locator and AP change. In both cases, the locator information in the PIT entries of the PIT 240 indexed by the UE-PIT index table 270 needs to be modified.

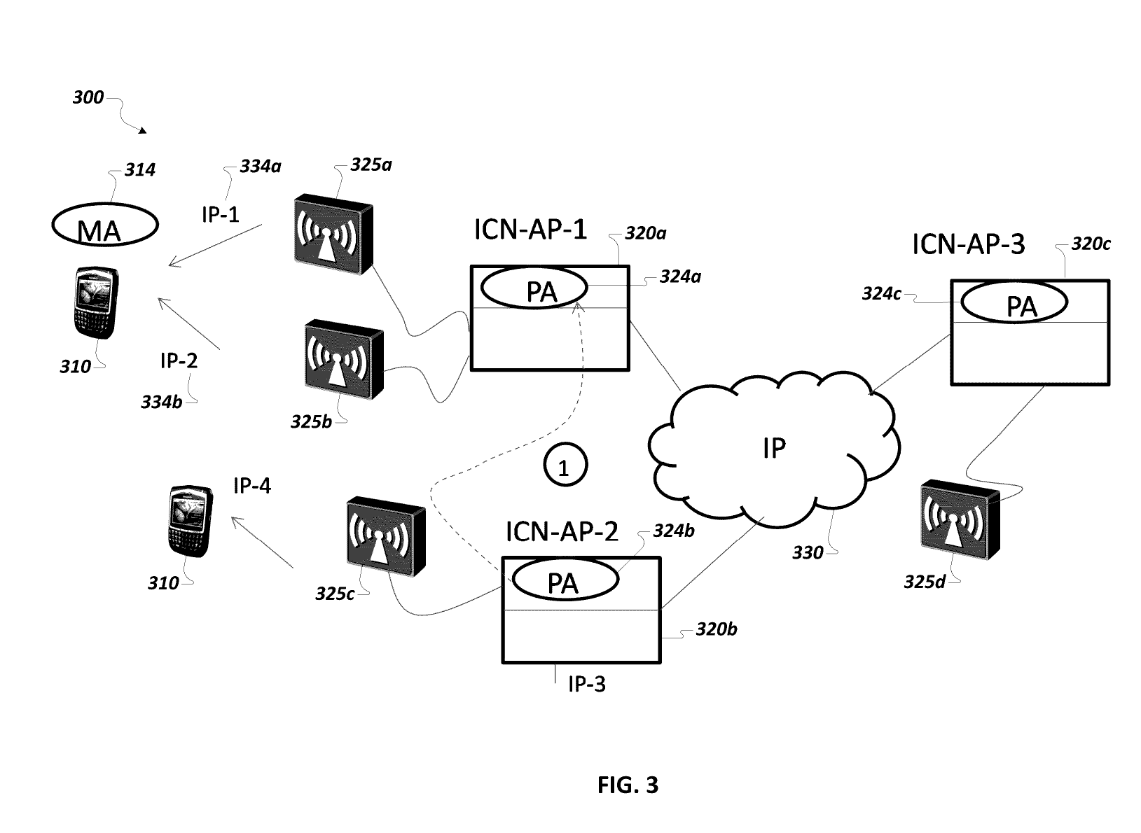

FIG. 3 is a block diagram showing an example ICN 300 that is configured to handle consumer mobility both within a same AP and between different APs. The example ICN 300 includes a data consumer, UE 310, and multiple ICN routers 320a-c overlaid over an IP network 330. Each of the multiple ICN routers 320a-c may include one or more subnets, each subnet associated with a respective access point (for example, access point 325a-d) and the ICN routers 320a-c can serve as the AP of the UE 310 as the UE 310 moves. For example, the ICN router ICN-AP-1 320a includes two subnets 334a and 334b associated with access points 325a and 325b respectively. The UE can include an MA 314 and the multiple ICN routers 320a-c can include respective PA 324a-c for executing control and forwarding functions to support seamless consumer mobility.

When the UE 310 moves within the same AP (for example, from the subnet 334a of the access point 325a to another subnet 334b of the access point 325b of the same ICN-AP-1 320a), the MA 314 of the UE 310 can signal the PA 324a of the ICN-AP-1 320a with the new locator information (for example, the IP or interface address of the new access point 325b). The signaling transmitted by the MA 314 to the PA 324a can include the UE ID of the UE 310. The PA 324a can use the UE ID of the UE 310 to signal the forwarding layer of the ICN-AP-1 320a to modify the PIT entry stored at the ICN-AP-1 320a to ensure data flows back to the correct IP address. When receiving the signaling, the PA 324a of the ICN-AP-1 320a then goes through the list of pending PIT entries in the PIT and modifies the old locator (for example, the address associated with the subnet 334a of the access point 325a) with the new locator information (for example, the address associated with the subnet 334b of the access point 325b) in the corresponding PIT entry.

When the UE 310 moves between the APs (for example, from ICN-AP-1 320a to ICN-AP-2 320b), the mobility can be explicitly expressed by the network. For example, the PA 324b in the new ICN-AP-2 320b can signal the previous ICN-AP-1 320a about the new locator. The new ICN-AP-2 320b can also inform its IP reachability to the PA 324a of the old ICN-AP-1 320a. The IP reachability includes information of whether the new ICN-AP-2 320b is a single IP hop away from the old ICN-AP-1 320a, or the new ICN-AP-2 320b and the old ICN-AP-1 320a are reachable through multiple IP hops. The PA 324a of the old ICN-AP-1 320a applies the similar logic as before, which is to identify the UE interest packets based on the UE ID and update the PIT entries at the ICN-AP-1 320a to ensure the data response to be forwarded to the new ICN-AP-2 320b.

In some implementations, there can be scenarios where the two APs are not reachable within a single IP hop but have a segment of intermediate ICN routers. In this case, the example techniques can still take advantage of the state information in the old AP. For example, the PA at the new AP can request the pending interest packets associated with the UE, which are stored at the old AP. The new AP then can express the pending interest packets specific for the UE, for example, by sending, to the old AP, interest packets including the UE ID and the data names listed in the received pending interest packets. These interest packets can be satisfied by the old AP or from the network (depending on the routing). Thereafter, when the UE re-expresses the interest packet (for example, sending the interest packets to the new AP requesting for the named data), there is very good chance of cache hit at the new AP.

In some implementations, in order to distinguish such re-directed data packet for a moved consumer, from data packet corresponding to a stationary consumer, the re-directed data packet can be labeled or otherwise marked to this effect, for example, by a mobility tag. The mobility tag can notify the new AP to cache the data packet irrespective of availability of the PIT entry requested from the UE who is expected to request the pending interest packets. Overall, the example techniques for handling mobility leverage the returning data packet to be re-directed and made available when the UE re-expresses those interest packets.

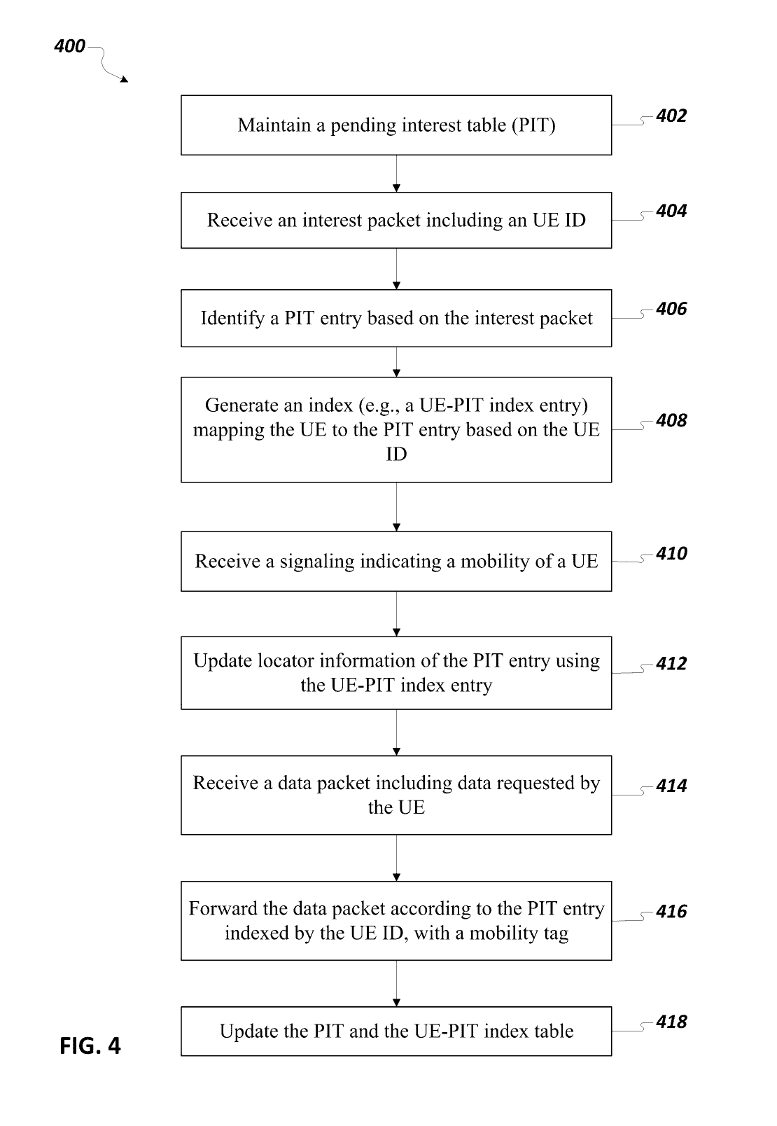

FIG. 4 is a flow chart of an example process 400 for handling consumer mobility in an ICN. The process 400 can be implemented as computer instructions stored on computer-readable media (for example, the computer-readable medium) and executable by data processing apparatus (for example, processors) of a network node of an ICN. For example, the process 400 can be implemented by an attachment point of a user equipment (UE) in an ICN that includes a number of network nodes. The process 400 can be implemented by the ICN routers (for example, the ICN routers 120a-d, 220, 320a-c in FIGS. 1-3, respectively). The example process 400, individual operations of the process 400, or groups of operations may be iterated or performed simultaneously (for example, using multiple threads). In some cases, the example process 400 may include the same, additional, fewer, or different operations performed in the same or a different order.

At 402, a pending interest table (PIT) is maintained. In some implementations, maintaining a PIT includes, for example, generating a PIT, adding a new entry in the PIT, updating information included in the PIT, deleting an entry in the PIT, storing the PIT in a computer-readable storage device, or other operations on the PIT. For example, an attachment point (for example, any of the ICN routers 120a-d, 220, or 320a-c) can generate and store a PIT (for example, the PIT 240) in a computer-readable storage device (for example, memory, cache, or other computer-readable medium) associated with the attachment point.

A PIT can include one or more PIT entries (for example, the PIT entries 241-243), each of the one or more PIT entries identifying unsatisfied data requested by one or more UEs based on the interest packets that were previously received by the attachment point. The unsatisfied data refer to the data specified in one or more interest packets that were previously received but have not been responded to by the attachment point. In other words, the unsatisfied data include data that are requested by a UE but has not been sent back, by the attachment point, to the UE. For example, the attachment point can receive one or more interest packets from one or more UEs. Each interest packet can include the name of the data requested by the UE. Upon the receipt of the interest packets, the attachment point can generate a respective PIT entry that includes the name of the data and corresponding locator information for the received interest packets. The locator information can include incoming and/or forwarding addresses (including, for example, ports, interfaces, IP address, etc.) for the interest packet. For example, the incoming addresses can include one or more downstream interfaces or host addresses that the interest packet comes from or traverses through. The forwarding addresses can include one or more upstream interfaces or host addresses of next-hop network nodes or the data producer(s). Here, the downstream refers to the direction or the path from the data producer to the data consumer; while the upstream refers to the direction or the path from the data consumer to the data producer. The locator information can be obtained, for example, based on metadata or other information (for example, header, suffix, prefix, etc.) of packets. The attachment point can determine the forwarding path of the interest packet and data packet according to the locator information in the PIT entries, for example, based on the state information saved by the attachment point when it receives the interest packets.

At 404, an interest packet including an identifier (ID) of a UE (hereinafter, UE ID) and a name of data that the UE requests to receive from one of the network nodes through the ICN is received by the attachment point. Examples of the UE ID are described above with reference to UE ID 284 of FIG. 2. The UE ID can keep track of the UE regardless of the UE's movement or location and thus can be used for handling consumer mobility in the ICN.

At 406, a PIT entry is identified based on the interest packet. The PIT entry corresponds to the received interest packet. For example, the PIT entry includes the name of the data requested by the UE in the interest packet. In some implementations, identifying the PIT entry can include looking up the name of the data in the PIT to find a matching entry that includes the name of the data that the UE requested in the interest packet. If a matching entry exists, the attachment point can update the locator information of this PIT entry to record the incoming interface of the interest packet. If no such a matching entry exist, identifying the PIT entry can include generating a new PIT entry with the name of the data and the incoming interface of the interest packet, for example, according to the example techniques described with respect to 402, or in another manner. The PIT entry can be added into the PIT and maintained by the attachment point.

The attachment point can forward the interest packet upstream toward the data producer(s), for example, based on information in the FIB as well as the router's adaptive forwarding strategy. In some implementations, the attachment point can append the UE ID, if not already included, to the interest packet and forward the interest packet with the UE ID to the next hop.

At 408, an index mapping the UE to the PIT entry based on the UE ID is generated. The index can be a UE-specific data structure that references or indexes the PIT entry in the PIT that is associated with the UE. The index can be implemented as a pointer, a reference, a map, or another data structure. The PIT entry can be, for example, the existing matching PIT entry or the newly generated PIT entry identified based on a newly received interest packet. In some implementations, the attachment point can generate an index per UE and store the index as an entry of a UE-PIT index table (for example, the UE-PIT index table 270). As such, the index can be referred to as an UE-PIT index entry.

The UE-PIT index table can be a data structure created to keep track of the pending interests from a UE, for example, for handling consumer mobility in ICN by referencing the PIT entries associated with the UE based on the UE ID. The UE-PIT index table can include multiple UE-PIT index entries, each UE-PIT index entry corresponds to a respective UE. For example, the UE-PIT index table 270 in FIG. 2 is an example UE-PIT index table that includes multiple UE-PIT entries 271-273. Each of the entries 271-273, identified by the UE ID, indexes into the respective PIT entries associated with the UE (for example, PIT entries 241-243) in the PIT 240. The UE-PIT index table can include additional or different information. The specific implementations of the UE-PIT index table and/or PIT is not limited to a table; it can include an array, a matrix, a cell, a construct, a tree, a graph, or a combination of these and other data structures. In some implementations, the UE-PIT index table is a collection of the indexes mapping the UE to the PIT entry based on the UE ID. The UE-PIT index table or PIT may be empty when no pending interest exists.

The attachment point can maintain the UE-PIT index table, for example, by generating the UE-PIT index table, adding a new index entry into the UE-PIT index table, updating information included in the UE-PIT index table, deleting an entry in the UE-PIT index table, storing the UE-PIT index table in a computer-readable storage device, or otherwise operating on the UE-PIT index table.

At 410, a signaling that indicates a mobility of the UE is received. In some implementations, the attachment point can receive the signaling from the UE or from another network node. For example, the control plane of the attachment point (for example, the PA 324a of the attachment point 320a in FIG. 3) can receive the signaling from the UE (for example, the MA 314 of the UE 310) or from another network node (for example, the PA 324b of the attachment point 320b) about the new locator information of the UE.

In some instances, the UE may move between two subnets of a single AP. For example, the signaling can indicate a mobility of the UE from a first subnet (for example, the subnet 334a) to a second subnet (for example, the subnet 334a) of the same attachment point (for example, the ICN-AP-1 320a). In some implementations, the indication of the mobility can be explicit, for example, for an overlaid mode where the UE and the ICN routers have a fully meshed IP connectivity, and in other case where multiple ICN hops exist to connect any two network nodes.

In some instances, the UE may move between APs. For example, the UE can move from a coverage area of the attachment point to another area covered by a second network node. In this case, the UE may attach to or otherwise establish communications with the second network node and use the second network node as the new attachment point (new AP). The previous attachment point can be referred to as the first attachment point or the old attachment point. The first attachment point can receive the signaling from the new attachment point. For instance, the signaling can be explicitly transmitted to indicate a mobility of the UE to the new attachment point. The new attachment point can notify the first attachment point about the reachability of the new attachment point (for example, whether the new attachment point is reachable within a single IP hop, or within multiple IP hops through intermediate ICN nodes).

At 412, locator information of the PIT entry is updated using the UE-PIT index entry. For example, the received mobility signaling can include the UE ID. Updating locator information of the PIT entry using the UE-PIT index entry can include identifying the PIT entry associated with the UE based on the index mapping the UE to the PIT entry; and updating the locator information in the PIT entry associated with the UE. For example, based on the UE ID, the attachment point can identify a matching UE-PIT-Index entry (for example, with the UE ID) in the UE-PIT-Index table, and further identify the PIT entry associated with the UE based on the identified UE-PIT-Index entry that maps the UE to the PIT entry. The attachment point can then update the locator information in the PIT entry to reflect the new locator information of the UE (for example, the port or address information of the second subnet or the new attachment point). As such, any requested data received by the attachment point will be re-directed to the address specified by the new locator information.

At 414, a data packet is received by the attachment point. The data packet can include the data requested by the UE, for example, before the UE moves to the new location. The data packet can include the name of the requested data. Based on which, the attachment point can identify a matching PIT entry in the PIT, which corresponds to the requested data.

At 416, the data packet is forwarded, by the attachment point, according to the locator information in the identified PIT entry indexed by the UE ID. Forwarding the data packet according to the PIT entry can include identifying the PIT entry that includes the name of the data requested by the UE; and forwarding the data packet to the address identified in the updated locator information in the PIT entry. In some implementations, the attachment point can forward the data packet to the address identified in the updated locator information in the PIT entry. In some implementations, the attachment point can forward the data to some or all down-stream addresses listed in the PIT entry. For example, in the case of the UE mobility between subnets of the attachment point, the data packet can be forwarded to the second subnet so that the data packet can be subsequently delivered to the UE by the second subnet. In the case of the UE mobility between attachment points, the data packet can be re-directed to the new attachment point so that it can be subsequently delivered to the UE by the new attachment point.

In some implementations, the attachment point can cache the data packet in the content store, for example, for a certain time period and remove the data packet after the elapse of the time period.

In some implementations, the attachment point can attach a mobility tag to the data packet. The mobility tag can indicate that the data packet is requested by the UE that has moved. The mobility tag can signify the receiver of the data packet (for example, the new attachment point) to cache the data packet even if there is no pending interest corresponding to the data packet stored by the receiver. For instance, the mobility tag can be implemented as one or more binary bits or another form of signaling that instructs the new attachment point, to which the UE has moved, to store the data packet despite an absence of an existing PIT entry that includes the name of the data requested by the UE in a computer-readable storage device of the new attachment point. In this way, the new attachment point can take advantage of the returned data re-directed from the first attachment point and satisfy the data request when the UE re-expresses the interest of the data without reaching all the way to the data producer to retrieve the data.

At 418, the PIT and the UE-PIT index table are updated. For example, in response to forwarding the requested data to one or more downstream nodes (for example, the UE or another network node), the attachment point can remove, from the PIT in the computer-readable storage device, the matching PIT entry that includes the name of the data requested by the UE because the pending interest has been satisfied. Additionally, the attachment point can update the corresponding UE-PIT index entry in the UE-PIT index table to remove the mapping from the UE to the PIT entry.

In some implementations, when the UE moves between two APs, the two APs may not be reachable within a single IP hop. For example, there may be multiple IP hops (for example, through multiple intermediate ICN routers) between the new attachment point and the first attachment point. The new attachment point can send, to the first attachment point, a request for a list of pending interests for the UE. For example, the request can include the UE ID, requesting for one or more PIT entries associated with the UE stored in the computer-readable storage device of the first attachment point. Upon receipt of the request, the first attachment point can identify the matching UE-PIT index entry based on the UE ID and then identify the PIT entries associated with the UE mapped by the UE-PIT index entry. The first attachment point can then send the PIT entries associated with the UE to the new attachment point.

In response to receiving the list of pending interests, the new attachment point can express the interests for the UE, for example, by generating and sending interest packets to the first attachment point, forcing the interest packets to be routed towards the first (i.e., the old) attachment point and in this case the data packets trace back the interest packets to the new attachment point. These interest packets can be tagged or otherwise marked to indicate that the interest packets are for handling consumer mobility.

When the first attachment point receives the interest packets, it can respond to them if the data/content corresponding to the interest packets are cached at the first attachment point. Or the first attachment point can aggregate these interest packets so that when the data responses are received, the first attachment point can send the responded data packets to the new attachment point. Similar to the example implementations of 416, the responded data can be attached with a mobility tag by the old attachment point so that the data is not dropped but saved in the content store for a period of time by the new attachment point even if there are no pending interests yet from the UE at the new attachment point. As such, when the UE re-expresses the interest for the data after it moved to the second network, the new attachment point can search in its content store for the matching data and return the requested data to the UE without fetching the data from the data producer.

Implementations of the subject matter and the operations described in this disclosure can be implemented in digital electronic circuitry, or in computer software, firmware, or hardware, including the structures disclosed in this disclosure and their structural equivalents, or in combinations of one or more of them. Implementations of the subject matter described in this disclosure can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium, for example, the computer-readable medium, can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical and/or non-transitory components or media (for example, multiple CDs, disks, or other storage devices).

In some implementations, the operations described in this disclosure can be implemented as a hosted service provided on a server in a cloud computing network. For example, the computer-readable storage media can be logically grouped and accessible within a cloud computing network. Servers within the cloud computing network can include a cloud computing platform for providing cloud-based services. The terms “cloud,” “cloud computing,” and “cloud-based” may be used interchangeably as appropriate without departing from the scope of this disclosure. Cloud-based services can be hosted services that are provided by servers and delivered across a network to a client platform to enhance, supplement, or replace applications executed locally on a client computer. The system can use cloud-based services to quickly receive software upgrades, applications, and other resources that would otherwise require a lengthy period of time before the resources can be delivered to the system.

The operations described in this disclosure can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device (for example, a universal serial bus (USB) flash drive), to name just a few. Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this disclosure can be implemented on a computer having a display device, for example, a CRT (cathode ray tube) or LCD (liquid crystal display) monitor, for displaying information to the user, and a keyboard, a pointing device, for example, a mouse or a trackball, or a microphone and speaker (or combinations of them) by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this disclosure can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this disclosure, or any combination of one or more such back-end, middleware, or front-end components. The components of the system can be interconnected by any form or medium of digital data communication, for example, a communication network. Examples of communication networks include a local area network (“LAN”) and a wide area network (“WAN”), an inter-network (for example, the Internet), and peer-to-peer networks (for example, ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (for example, an HTML page) to a client device (for example, for purposes of displaying data to and receiving user input from a user interacting with the client device). Data packet generated at the client device (for example, a result of the user interaction) can be received from the client device at the server.

While this disclosure contains many specific implementation details, these should not be construed as limitations on the scope of any implementations or of what may be claimed, but rather as descriptions of features specific to particular implementations of particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by an attachment point of a user equipment (UE) in an information-centric network (ICN) that includes a plurality of network nodes, the method comprising:
maintaining, by the attachment point and in a computer-readable storage device, a pending interest table (PIT) that includes one or more PIT entries, each of the one or more PIT entries identifying unsatisfied data requested by the UE, wherein the data requested by the UE are specified in one or more interest packets that were previously received by the attachment point;
receiving, at the attachment point, an interest packet including an identifier (ID) of a UE and a name of data that the UE requests to receive from one of the plurality of network nodes through the ICN;
identifying, by the attachment point, a PIT entry of the PIT, the PIT entry including the name of the data requested by the UE in the interest packet; and
generating, by the attachment point, an index mapping the UE to the PIT entry based on the ID of the UE.

2. The method of claim 1, wherein the PIT entry further includes locator information, the locator information including an address to which the attachment point is to forward the data requested by the UE, the method further comprising:
receiving a signaling indicating a mobility of the UE, the signaling including the ID of the UE;
identifying the PIT entry associated with the UE based on the index mapping the UE to the PIT entry; and
updating the locator information in the PIT entry associated with the UE.

3. The method of claim 2, further comprising:
receiving a data packet including the data requested by the UE;
identifying the PIT entry that includes the name of the data requested by the UE; and
forwarding the data packet to the address identified in the updated locator information in the PIT entry.

4. The method of claim 3, further comprising:
deleting, from the PIT in the computer-readable storage device, the PIT entry that includes the name of the data requested by the UE; and
updating the index mapping the UE to the PIT entry to remove the mapping from the UE to the PIT entry.

5. The method of claim 2,
wherein receiving a signaling indicating a mobility of the UE comprises receiving, from the UE, the signaling indicating a mobility of the UE from a first IP subnet to a second subnet of the attachment point; and
wherein updating the locator information in the PIT entry associated with the UE comprises updating the locator information in the PIT entry associated with the UE to include an address of the second subnet of the attachment point.

6. The method of claim 2,
wherein receiving a signaling indicating a mobility of the UE comprises receiving, from a second network node, the second network node being a new attachment point of the UE, the signaling indicating a mobility of the UE from the attachment point to the new attachment point; and
wherein updating locator information in the PIT entry associated with the UE comprises updating locator information in the PIT entry associated with the UE to include an address of the new attachment point.

7. The method of claim 6, further comprising:
receiving, from the new attachment point, a request for one or more PIT entries associated with the UE stored in the computer-readable storage device of the attachment point; and
in response to receiving the request, sending the one or more PIT entries associated with the UE stored in the computer-readable storage device of the attachment point to the new attachment point.

8. The method of claim 7, further comprising:
receiving, from the new attachment point, one or more interest packets; and
sending, to the new attachment point, data corresponding to the one or more interest packets if the data corresponding to the one or more interest packets are stored in the computer-readable storage device of the attachment point or when the data corresponding to the one or more interest packets are received by the attachment point.

9. The method of claim 6, further comprising:
receiving a data packet including the data requested by the UE;
identifying the PIT entry that includes the name of the data requested by the UE; and
attaching, by the attachment point, a mobility tag to the data packet, wherein the mobility tag signifying the new attachment point to store the data packet despite an absence of an existing PIT entry that includes the name of the data requested by the UE in a computer-readable storage device of the new attachment point; and
forwarding, to the new attachment point, the data packet with the mobility tag based on the updated locator information in the PIT entry.

10. A network node comprising:
a computer-readable storage device; and
at least one hardware processor interoperably coupled with the computer-readable storage device and configured to operate as an attachment point of a user equipment (UE) in an information-centric network (ICN) that includes a plurality of network nodes, the at least one hardware processor configured to perform operations comprising:
maintaining, by the attachment point and in the computer-readable storage device, a pending interest table (PIT) that includes one or more PIT entries, each of the one or more PIT entries identifying unsatisfied data requested by the UE, wherein the data requested by the UE are specified in one or more interest packets that were previously received by the attachment point;
receiving, at the attachment point, an interest packet including an identifier (ID) of a UE and a name of data that the UE requests to receive from one of the plurality of network nodes through the ICN;
identifying, by the attachment point, a PIT entry of the PIT, the PIT entry including the name of the data requested by the UE in the interest packet; and
generating, by the attachment point, an index mapping the UE to the PIT entry based on the ID of the UE.

11. The network node of claim 10, wherein the PIT entry further includes locator information, the locator information including an address to which the attachment point is to forward the data requested by the UE, the operations further comprising:
receiving a signaling indicating a mobility of the UE, the signaling including the ID of the UE;
identifying the PIT entry associated with the UE based on the index mapping the UE to the PIT entry; and
updating the locator information in the PIT entry associated with the UE.

12. The network node of claim 11, the operations further comprising:
receiving a data packet including the data requested by the UE;
identifying the PIT entry that includes the name of the data requested by the UE; and
forwarding the data packet to the address identified in the updated locator information in the PIT entry.

13. The network node of claim 12, the operations further comprising:
deleting, from the PIT in the computer-readable storage device, the PIT entry that includes the name of the data requested by the UE; and
updating the index mapping the UE to the PIT entry to remove the mapping from the UE to the PIT entry.

14. The network node of claim 11,
wherein receiving a signaling indicating a mobility of the UE comprises receiving, from the UE, the signaling indicating a mobility of the UE from a first subnet to a second subnet of the attachment point; and
wherein updating the locator information in the PIT entry associated with the UE comprises updating the locator information in the PIT entry associated with the UE to include an address of the second subnet of the attachment point.

15. The network node of claim 11,
wherein receiving a signaling indicating a mobility of the UE comprises receiving, from a second network node, the second network node being a new attachment point of the UE, the signaling indicating a mobility of the UE from the attachment point to the new attachment point; and
wherein updating locator information in the PIT entry associated with the UE comprises updating locator information in the PIT entry associated with the UE to include an address of the new attachment point.

16. A non-transitory, computer-readable medium storing computer-readable instructions executable by an attachment point of a user equipment (UE) in an information-centric network (ICN) that includes a plurality of network nodes to perform operations, the operations comprising:
maintaining, by the attachment point and in the computer-readable storage medium, a pending interest table (PIT) that includes one or more PIT entries, each of the one or more PIT entries identifying unsatisfied data requested by the UE, wherein the data requested by the UE are specified in one or more interest packets that were previously received by the attachment point;
receiving, at the attachment point, an interest packet including an identifier (ID) of a UE and a name of data that the UE requests to receive from one of the plurality of network nodes through the ICN;
identifying, by the attachment point, a PIT entry of the PIT, the PIT entry including the name of the data requested by the UE in the interest packet; and
generating, by the attachment point, an index mapping the UE to the PIT entry based on the ID of the UE.

17. The computer-readable medium of claim 16, wherein the PIT entry further includes locator information, the locator information including an address to which the attachment point is to forward the data requested by the UE, the operations further comprising:
receiving a signaling indicating a mobility of the UE, the signaling including the ID of the UE;
identifying the PIT entry associated with the UE based on the index mapping the UE to the PIT entry; and
updating the locator information in the PIT entry associated with the UE.

18. The computer-readable medium of claim 17, the operations further comprising:
receiving a data packet including the data requested by the UE;
identifying the PIT entry that includes the name of the data requested by the UE; and
forwarding the data packet to the address identified in the updated locator information in the PIT entry.

19. The computer-readable medium of claim 18, the operations further comprising:
deleting, from the PIT in the computer-readable storage medium, the PIT entry that includes the name of the data requested by the UE; and
updating the index mapping the UE to the PIT entry to remove the mapping from the UE to the PIT entry.

20. The computer-readable medium of claim 17,
wherein receiving a signaling indicating a mobility of the UE comprises receiving, from the UE, the signaling indicating a mobility of the UE from a first subnet to a second subnet of the attachment point; and
wherein updating the locator information in the PIT entry associated with the UE comprises updating the locator information in the PIT entry associated with the UE to include an address of the second subnet of the attachment point.
